(19) United States
(12) Patent Application Publication
(10) Pub. No.: US 2014/0156545 A1
(43) Pub. Date: Jun. 5, 2014

(54) Automated Generation Of Affidavits And Legal Requisitions Including Mobile Device Identification

(71) Applicant: Absolute Software Corporation, Vancouver (CA)

(72) Inventors: Ward Clapham, Surrey (CA); Tedric Mah, Vancouver (CA); Damien Loveland, Richmond (CA); Stephen Treglia, Mineola, NY (US); William Doyle Gordon, Vancouver (CA)

(73) Assignee: Absolute Software Corporation, Vancouver (CA)

(21) Appl. No.: 14/095,916

(22) Filed: Dec. 3, 2013

Related U.S. Application Data
(60) Provisional application No. 61/733,276, filed on Dec. 4, 2012.
(60) Provisional application No. 61/878,756, filed on Sep. 17, 2013.

(51) Int. Cl. G06Q 50/18; G06Q 10/00

(52) U.S. Cl. CPC G06Q 50/18; G06Q 10/00
USPC 705/311

(57) ABSTRACT

Approaches for a server, upon receiving notification that a device has been stolen, composing a legal requisition document. An identification of the device is received or otherwise obtained. A legal requisition template for use in a particular jurisdiction where the device was stolen is retrieved. Upon consulting a database which stores information about police departments of a plurality of jurisdictions, the legal requisition document is composed using the template, the identification, and data retrieved from the database. The server may electronically send the legal requisition document to a police department associated with the particular jurisdiction. Advantageously, information about the activity of a device reported stolen may be obtained before the device is factory reset.

### CLAIM OF PRIORITY

This application claims priority to U.S. Provisional Patent Application No. 61/733,276, entitled “Automated Generation of Affidavits and Legal Requisitions Including Mobile Device Identification,” invented by Stephen Treglia et al., filed on Dec. 4, 2012, the contents of which are hereby incorporated by reference for all purposes as if fully set forth herein.

This application also claims priority to U.S. Provisional Patent Application No. 61/878,756, entitled “Automated Generation of Affidavits and Legal Requisitions Including Mobile Device Identification (Extended),” invented by Ward Clapham et al., filed on Sep. 17, 2013, the contents of which are hereby incorporated by reference for all purposes as if fully set forth herein.

### FIELD OF INVENTION

The present disclosure generally relates to the protection of electronic devices from theft, and in particular, to approaches for generating affidavits and legal requisition documents used to support the investigation of such thefts.

### BACKGROUND

Personal electronic computing or communications devices such as laptops, netbooks, cell phones, personal digital assistants, smart phones, memory sticks, personal media devices, gaming devices, tablet computers, electronic books and personal computers are often lost or stolen. Since proprietary information is routinely stored on such devices, the need to protect such proprietary or sensitive data and to recover such devices is self-evident.

Due to the proliferation of mobile devices for work purposes, many companies use some kind of mobile device management (MDM) system, in which a central server controls the applications on the mobile devices, updates the security software on the mobile devices and keeps track of the IP addresses of the mobile devices. During communications with a managed device that has been stolen, the MDM server may send commands for data deletion, encryption, encryption key deletion, retrieving data, etc.

Security actions, such as deleting data, while useful in themselves, do not necessarily help to recover a stolen device. In contrast, tracking IP addresses can be very effective in recovering stolen property. One problem is that stolen devices are often restored to factory settings soon after being stolen, and any MDM management applications on the device are removed, preventing the capture of further IP addresses. Another problem with recovering stolen devices is that such thefts are usually designated with too low a priority within a police department compared to other crimes. In particular, the perceived worth of the loss can be very small compared to the effort required to obtain enough IP addresses to launch an investigation that has a high probability of success.

In some cases, a thief or bona fide purchaser of a stolen device will use the device to connect to an online music or media store, and in doing so, will provide her personal details to the store. Such a store may also maintain IP addresses of the device. However, the store is not aware that the device has been stolen and is not obliged to reveal private information relating to the person accessing the store, nor to reveal IP address information.

### SUMMARY

As soon as mobile devices, which are registered with an MDM system, are reported stolen, the MDM system captures as much location information as possible before the device is factory reset. This location information is sent to the investigating police officer, together with a pre-prepared affidavit and search warrant, the warrant for retrieving data relating to the stolen device from an online media store that the device has connected to. If there are any sections of the affidavit and search warrant to be completed, the officer may complete them, either by typing in directly or making selections from pull down menus. The officer then sends the location information, affidavit and search warrant to the local judge for the warrant to be signed. Using pre-prepared affidavits and search warrants saves the police a tremendous amount of administrative effort. When the police officer gets the signed search warrant, he can then send it to the online company that operates the online store. The online store then becomes obliged to provide the requested personal and device data to the police. While nationally there are very many thefts of this nature, individual officers are not likely to frequently come across cases of this type, so by providing a systematic solution to the problem of recovering such devices, a significant burden is lifted from such officers.

This summary is not an extensive overview intended to delineate the scope of the subject matter that is described and claimed herein. The summary presents aspects of the subject matter in a simplified form to provide a basic understanding thereof, as a prelude to the detailed description that is presented below. Neither this summary, the drawings nor the following detailed description purport to define or limit the invention; the invention is defined only by the claims.

### BRIEF DESCRIPTION OF THE DRAWINGS

For a fuller understanding of the nature and advantages of the disclosed subject matter, as well as the preferred mode of use thereof, reference should be made to the following detailed description, read in conjunction with the accompanying drawings. In the drawings, like reference numerals designate like or similar steps or parts.

FIG. 1 is a schematic diagram of an overall system for the automated generation of affidavits and legal requisitions.

FIG. 2 is a schematic diagram of an automatically prepared affidavit in support of a request for a search warrant.

FIG. 3 is a schematic diagram of an appendix containing information retrieved from an MDM system and pertaining to a stolen device.

FIG. 4 is a schematic diagram of a search warrant for retrieving stolen device data from an online media store company.

FIG. 5 is a swim lane diagram showing the overall process related to registering a device through to investigation of its theft.

FIG. 6 is a flowchart of a process performed at the MDM server for preparing affidavits and search warrants.

FIG. 7 is an example of a legal document with pull-down options.

FIG. 8 is a process that is carried out to determine whether a device has contacted an online company.

### DETAILED DESCRIPTION OF SPECIFIC EMBODIMENTS

Prior to describing examples of embodiments of the invention, certain terms used throughout the specification shall be discussed. A device, as used herein, is any electronic device or any computing device to be protected. Non-limiting examples of a device include a laptop, cell phone, personal digital assistant, smart phone, memory stick, personal media device, gaming device, personal computer, tablet computer, electronic book, camera with a network interface, and netbook. Most devices protected by the invention will be mobile devices, but static devices, such as desk top computers, may also be protected. While the invention is often explained in relation to mobile devices, it is to be understood that it applies equally to static devices.

An Electronic Serial Number (ESN) is a unique number that identifies a device. An ESN may be stored in memory and/or in a register in the device.

A MDM (Mobile Device Management) Server, as used herein, refers to a computer or group of computers that devices contact frequently and briefly in order to receive awaiting commands, if any. Commands may be related to the management of the mobile devices, such as software to be installed, upgrades to be installed, modules to be repaired, notifications to be delivered, audits to be performed, security actions to be taken, etc. Communication between the devices and the MDM server may be, for example, via the internet (wired or wireless), via a wired or wireless telephone network, via cable or via satellite. An MDM server may be part of a monitoring center that tracks the location of mobile devices. An MDM server may receive notifications from owners of electronic devices that they have been lost or stolen, and as a result, may transmit a message to the lost or stolen electronic device that initiates some kind of security action. The action may be to lock the device, to sound an alarm, to delete data and/or to provide location information, for example. The action may be to provide a list of files on the device, retrieve files from the device, invoke processor based anti-theft features, encrypt data on the device, or delete an encryption key, etc. In general, the devices initiate calls to the MDM server, but depending on the configuration of the devices and the communication channels available to it, the MDM server may initiate contact with the devices, e.g. via SMS (Short message service).

As used herein, the term owner refers to either the actual owner of a device or a user who is authorized by the owner.

A subpoena is a writ by a court to compel production of evidence under a penalty for failure. It may be a request to mail copies of documents to the court. Subpoenas are usually issued by the clerk of the court in the name of the judge. It is the responsibility of the police to serve the subpoena on the party from whom the evidence is sought.

A search warrant is a court order issued by a judge or other court official that authorizes police officers to conduct a search of a location for evidence of a crime and to confiscate evidence if it is found. While much of the description herein is given in respect of search warrants, the invention applies equally to subpoenas.

The term legal requisition, as used herein, refers to either a subpoena or a search warrant.

The term factory reset refers to when an electronic device is returned to the electronic state it was in when it left the factory. All software added and configuration changes made to the device after leaving the factory are deleted or reset to factory defaults.

The detailed descriptions within are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps involve physical manipulations of physical quantities. Often, but not necessarily, these quantities take the form of electrical or magnetic signals capable of being stored, transferred, combined, compared, and otherwise manipulated. It will be further appreciated that the line between hardware, software and firmware is not always sharp, it being understood by those skilled in the art that software implemented processes may be embodied in hardware, firmware, or software, in the form of coded instructions such as in microcode and/or in stored programming instructions. In general, unless otherwise indicated, singular elements may be in the plural and vice versa with no loss of generality. The use of the masculine can refer to masculine, feminine or both. Drawings may not be to scale.

### Exemplary Embodiments

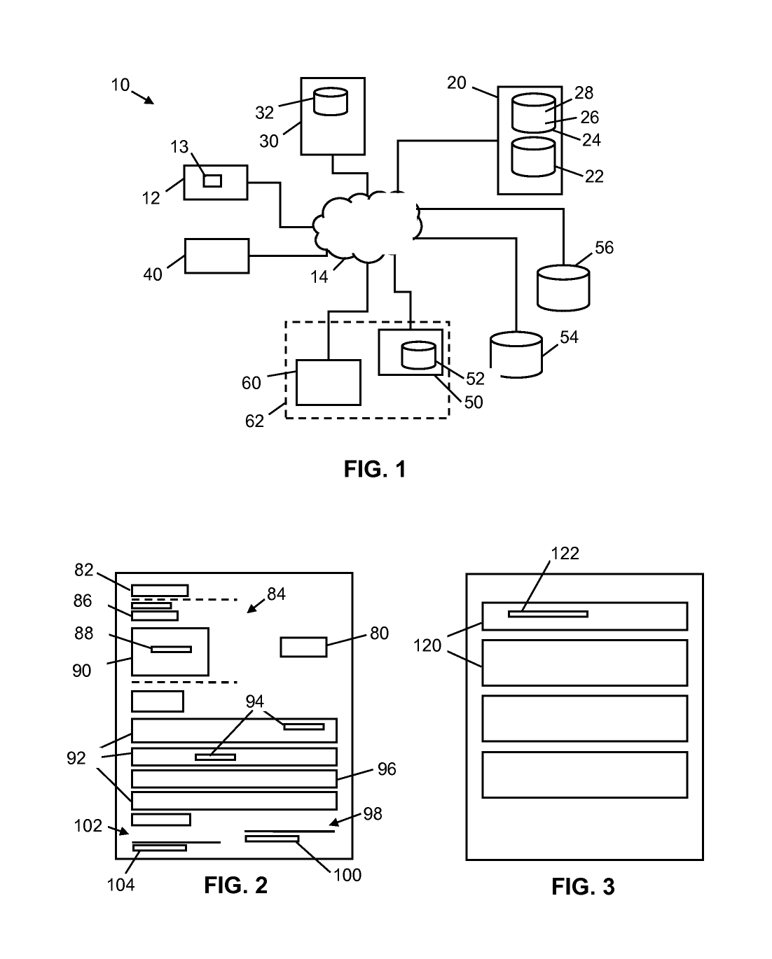

A symbolic block diagram of a preferred embodiment of the overall system 10 is shown in FIG. 1. Prior to theft, an owner's device 12 is connected via a network 14 to an MDM server 20. The network may be the internet, a telecommunications network, or a combination thereof. The device 12 may be connected to the network wirelessly or by wired or cable connections, and connections may be intermittent or continuous. This also applies for all other connections shown. The MDM server 20 causes an MDM module 13 to be installed in the device 12. The MDM module 13 is responsible for communications to the MDM server 20, and for performing commands received by the MDM server.

The device 12 is also shown connected to a server 30 forming part of an online media store, which provides music files, for example, to the device 12. Other types of electronic media may be provided by the online media store, such as videos, radio broadcasts, podcasts, books, applications, etc. The server 30 has a database 32 in which is stored information pertaining to the device, such as the device's serial number, the device's IP address as well as the owner's personal information, such as name, address and credit card number.

The MDM server 20 includes a database 22 for MDM purposes. Details of the device 12, such as serial number, ESN, name of owner, IP address, software installed, etc. are stored in MDM database 22. In the normal course of things, the device 12 is managed by MDM server 20. The MDM server also has a database 24 that comes into play when a device 12 is stolen. Database 24 stores one or more templates of affidavits 26 and one or more templates of search warrants 28. Also, optionally stored in database 24 are details of names of police officers, names of judges and names of online media companies correlated with location, such that the affidavit and search warrant templates can be automatically populated with such names upon specification of a location. Details of multiple online media companies may be stored in the database 24, and whether they are specific to certain kinds or makes of device.

When a device 12 is stolen, the owner reports the theft to the police local to where the theft occurred, using a terminal 40 connected to the network 14. Terminal 40 may be another device belonging to or in possession of the owner, such as a smart phone, or it may be a borrowed device. The report may be made by phone or online, or instead it may be made in person. Irrespective of how the report is made, the owner may be obliged to visit the police department in person. The same report may also be sent to the MDM server 20. A web interface may be provided by the MDM server 20 for the owner to make such reports.

Upon receiving the report of the theft, the MDM server 20 automatically invokes any security measures that have been defined in a security policy for the device 12. This involves the MDM server 20 sending one or more commands to the device 12 to protect data stored on the device or to restrict access to the device, for example. As well, and upon receiving approval from the police, the MDM server 20 collects as much IP address information for the device as possible, and as quickly as possible, considering that the thief may soon factory reset the device and as a result remove the MDM module 13 from the device. After the MDM module has been removed, the IP address of the device 12 can no longer be retrieved by the MDM server 20. Approval is obtained from the police, via terminal 50, for the MDM server 20 to be used as part of a criminal investigation. The police may send approval directly to the MDM server 20, or a user of the MDM server may offer help to the police and request approval to do so.

Also connected to the network 14 is a database 54 of police officers and police departments correlated and their corresponding locations. Database 54 may be a national database, one or more state-wide databases or one or more local databases 52 each accessible only to a particular police department. Also connected to the network 14 is a database 56 of judges and courts and their corresponding locations. Database 56 may be a national database, one or more state-wide databases or one or more local databases with limited access.

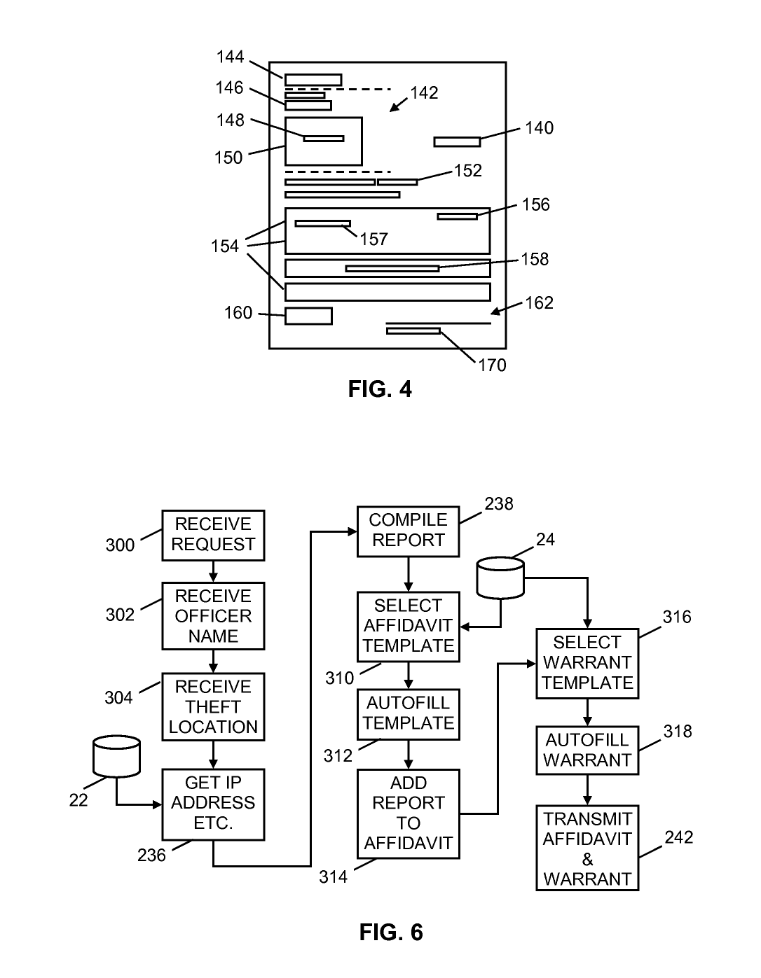

The MDM server 20 is configured to send pre-prepared affidavits (FIG. 2), search warrants (FIG. 4) and supporting information to the police accessing the network at 50. The police officer then completes the affidavit if necessary, prints it, executes it before a notary and sends it to a terminal 60 in the local court with the search warrant and supporting documents for signature of the warrant by a judge. The court is in the locality 62 of the police department 50.

An example of an automatically prepared affidavit in support of an application for a search warrant is shown in FIG. 2. It includes various standard parts, such as a document title 80, and various configurable parts, such as the name of the judge, county and state 82. It includes a header region 84 containing the name of the police officer 86, the specifics 90 of what the warrant is for and an identifier 88 for the stolen device. Standard form paragraphs 92 may be included, with configurable parts 94 related to the specifics of the crime, such as location, type of device stolen, identification of device, name of investigating officer, etc. One of the paragraphs 96 may include information of IP addresses etc. obtained by the MDM server 20. A signature region 98 for the officer named at 100 is provided, and a notary signature region 102 is provided for notary named at 104. There may be many more paragraphs in practice than shown and the affidavit may extend to several pages.

An attachment as shown in FIG. 3 may be included with the affidavit, the attachment including one or more standard paragraphs 120 describing the type of data required to be provided by the online media company. The device may be specified by serial number 122 or other identification.

An example of an automatically prepared search warrant is shown in FIG. 4. It includes various standard parts, such as a document title 140, and various configurable parts, such as the name of the judge, county and state 144. It includes a header region 142 containing the name of the police officer 146, the specifics 150 of what the warrant is for and an identifier 148 for the stolen device. The warrant may be prepared in the name of the people of the state mentioned at 152. Standard form paragraphs 154 may be included, with configurable parts related to the specifics of the crime, such as location, type of device stolen, identification of device, name of investigating officer 156, name of police department 157, location 158 of information sought etc. A date and place block 160 may be present and a signature region 162 for the judge named at 170 is provided.

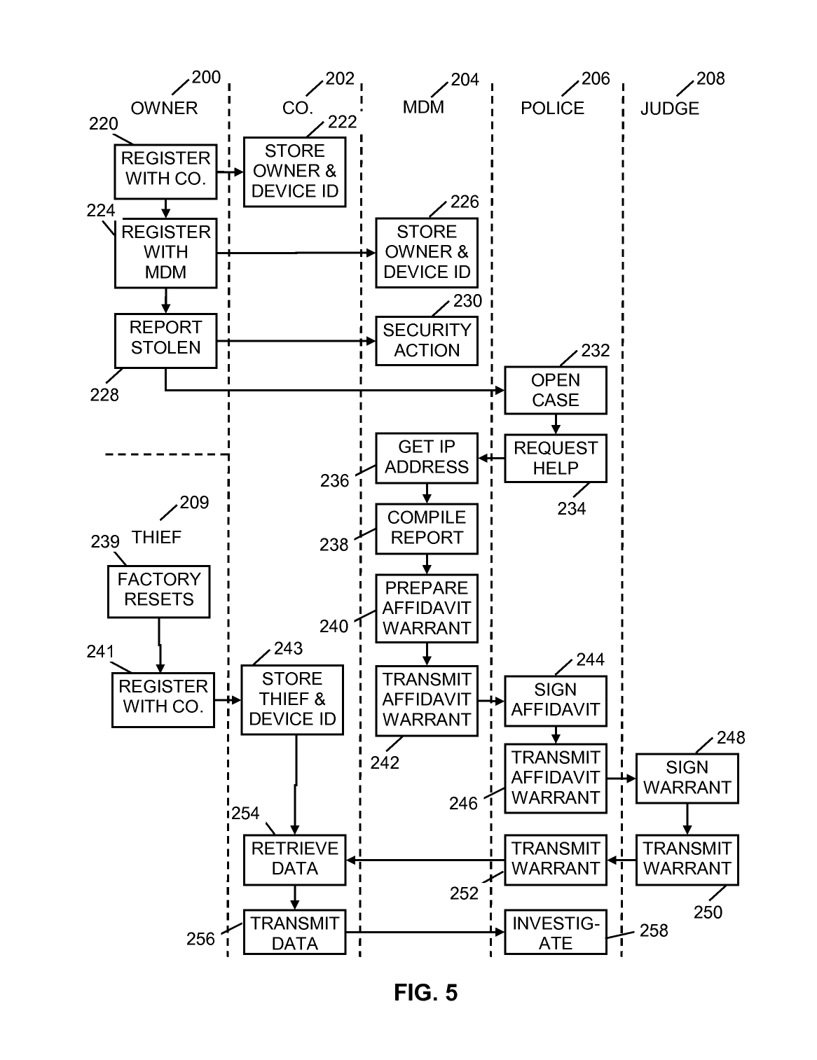

FIG. 5 shows the overall process and interrelation between the owner 200, the online media company 202, the MDM server 204, the police officer 206, the judge 208 and thief 209 further down the first swim lane. In step 220, the owner registers the device with the online media company, which then stores the owner's details and device identification in step 222. Step 222 is optional, and not necessary. The owner registers the devices with the MDM server in step 224, which may instead be done by an administrator using an MDM server. Such an administrator may be responsible for a multiple devices assigned to employees of a corporation or other entity. The MDM server stores details of the device and the owner of the device in step 226. In step 228, presuming that it is the case, the owner reports the device as having been stolen, to both the MDM server and the police. In step 230, the MDM server initiates any required security action. In step 232, the police open a case for the theft. The police then in step 234 request the help of the MDM server to try and recover as much information as possible before the device is removed from the MDM system by factory resetting it. On receipt of the request, or upon the police accepting an offer by the personnel operating the MDM system to help, the MDM server captures as much IP address and other pertinent information as possible, in step 236. In step 238, the MDM server compiles a report of location information about the device, ideally before the thief 209 resets the device in step 239. The MDM server prepares an affidavit and a search warrant in step 240, and then transmits, in step 242, the affidavit (including report) and search warrant to the police. The police officer then in step 244 executes the affidavit before a notary and in step 246 transmits the affidavit containing the supporting report, and the search warrant, to the judge. The judge, if approving of the affidavit, then signs the search warrant in step 248 and returns it in step 250 to the police officer. The officer may go to the court in person to collect it. The police officer then, in step 252, serves the warrant on the online media company. It may be sent electronically as well as by registered mail. Meanwhile, the thief, or bona fide purchaser of the stolen device, has registered with the online media company in step 241, which has recorded, in step 243, her name and credit card details in relation to the device identification. Upon receipt of the search warrant, the online media company, in step 254, retrieves all the requested data relating to the device, and sends it back to the police at step 256. The police then, in step 258, investigate the crime by, for example, visiting the residence of the thief and reclaiming the device.

FIG. 6 shows more of the detail of the process that occurs at the MDM server 20. In step 300, the MDM server receives the request from the police officer to proceed with IP address and other data collection. The MDM server receives, in step 302, the name of the police officer, and receives, in step 304, the location of the theft. The IP address etc. is obtained in step 236, using data stored in MDM database 22. A report is compiled by the MDM in step 238. Then, in step 310, an affidavit template is selected from database 24 based on the location of the crime. Each state may have its own particular preferred form of affidavit. The template is automatically populated in step 312 with the details of the police officer and the identification number of the stolen device. The report compiled in step 238 (FIG. 5) is added, in step 314, to the affidavit, for example as one or more of the paragraphs 96. A search warrant template is then selected in step 316 from the database 24, depending on the location of the crime. Again, each state, county or court may have its own preferred form of search warrant. The warrant is automatically populated in step 318, with the name of the court and judge in the locality of the police department to which the theft was reported. When the affidavit and the search warrant have been prepared, they are sent to the police officer, in step 242.

### Variations

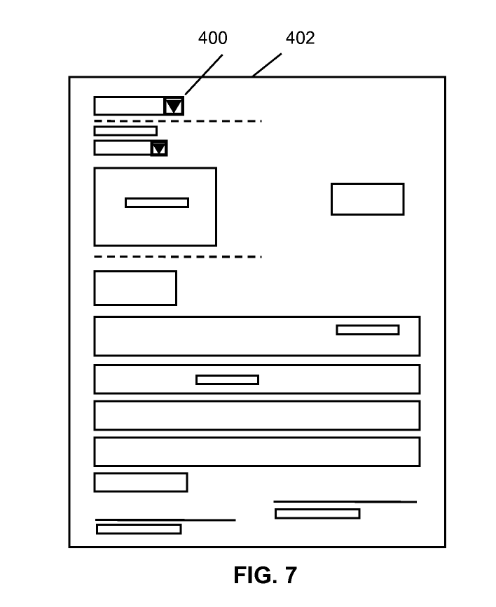

FIG. 7 shows an affidavit template with pull down selection options. Option 400 is for the name of the judge and option 402 is for the name of the police officer. Each of these options may optionally be populated from databases that have restricted access, such that the MDM personnel and the MDM server they operate do not have access to such names.

Signatures may be obtained electronically. For example, an electronic signature may be any electronic sound, symbol, or process attached to, or associated with, a document and adopted by a person with the intent to sign such a document. It may be an s-signature, for example. The affidavit may be sealed electronically. As such, documents may be delivered electronically.

Functions described as being performed by one server may be divided between separate servers, and functions described as being performed on multiple servers may be combined on the same server. Intermediate servers may also be employed in the system.

Databases may also be arranged in a different architecture to that shown herein. Databases may be split, duplicated, cached or located remotely in parts, for example.

Terminals shown as a single terminal may instead be multiple terminals, for example multiple terminals in a police department or court.

Steps in the flowcharts may be performed in a different order to that illustrated, or they may be combined where shown separately. Steps may be omitted and others added, and steps from different flowcharts may be interchanged, all without departing from the scope of the invention.

Parts of the process may be performed manually.

The system and process may be modified to be used for civil cases rather than criminal cases.

In the first 48 hours or so after the theft, the MDM server may capture information such as IP address, device location (e.g. by GPS, Wi-Fi triangulation), name of carrier, IMEI. This may be possible if the thief still has the device in an area where Wi-Fi access by the device is permitted, or where there is a 3G or other data network subscription. For example, a thief may steal a device on a campus, and may remain on campus for a while using, or allowing the device to use, the free Wi-Fi access provided by the campus.

While having been described in relation to devices managed by MDM systems, parts of this process can apply to any electronic device with a network interface, whether they are managed by MDM, managed by some other remote server or system, or not managed at all. For example, an individual user who has his device stolen may provide the device identification number to the police, who would then use it to automatically compile an affidavit in support of obtaining a signature for a search warrant, also automatically prepared, both the affidavit and search warrant being sent to the court. In this case, the police will use an affidavit and search warrant preparation system rather than an MDM system. Such an affidavit and search warrant preparation system may be local to a police department, state-wide or national with variations tailored to each state or court. Pull-down menus may be used for the names of the officers, judges and/or courts.

Data may be obtained from the online media company as part of the immediate post-theft action. For example, in step 236 (FIG. 5), IP addresses and other device identification and location information may additionally be retrieved from the online media company by the MDM system, or the affidavit and search warrant preparation system, provided that the owner has given such permission to the online media company in advance. Such permission may be given when the owner subscribes to the media service, for example. Continually, or upon the owner notifying the online media company that their device has been stolen, the online media company may make the information available through a secure interface to the MDM system or the affidavit and search warrant preparation system. Depending on privacy laws, the information made available may be limited to pre-theft information, or personal pre-theft information and both pre- and post-theft device-specific information. The information obtained may be used to supplement the report prepared in step 238. Information may be provided up until the moment of the factory reset. The search warrant later served on the media company will then be used to obtain further, post-theft information, which may include personal information relating to the thief.

While online media companies have been used to describe the invention, other internet-connected companies or services may equally be used. For example, a software company that provides automatic software updates to the device may be used as well, or instead of the online media company. This would likely provide device specific information and IP address information rather than personal information such as credit card numbers.

While the invention has been described in terms of factory resets, other techniques used to delete the MDM module 13 may be used instead, such as direct deletion of the MDM module.

Different quantities, time durations and other straightforward changes are also contemplated.

One of the steps in the investigation may well be for the police to serve the thief with a search warrant. This may also be automatically be generated in a similar way by the system in subsequent steps, together with a supporting affidavit and any necessary attachments. Information regarding the thief may be automatically added to these subsequent affidavits and search warrants based on information collected from the online media company.

The present description is of the best presently contemplated mode of carrying out the subject matter disclosed and claimed herein. The description is made for the purpose of illustrating the general principles of the subject matter and not be taken in a limiting sense; the subject matter can find utility in a variety of implementations without departing from the scope of the disclosure made, as will be apparent to those of skill in the art from an understanding of the principles that underlie the subject matter.

### Additional Variations

The security action 230 (FIG. 5) may be the automated sending of a theft report to the police, triggered by the reporting of the theft by the owner or authorized user of the device to the MDM server 204. Alternately, there may be a button or selection box displayed by the browser accessing the MDM server which allows the owner or authorized user to specify whether or not the MDM server should report the theft to the police or not. Automated theft reporting in this way is quicker and more efficient for the owner or authorized user and the police. The MDM server will already have the details of the device that has been stolen, such as make, model, serial number, color, owner's name, telephone number, address, email address and other pertinent details. If there is no response from the police then the report may be re-sent later, for example after a period of six weeks. Any additional evidence (e.g. location information) may also be summarized and sent to the police with the second and each subsequent report, if any. A further button may be made available to the owner to indicate whether more items were stolen at the same time, and details of those items could be entered in a text field (there and then, or at a later time) that is also forwarded to the police with the theft report for the stolen mobile device.

The security action 230 may be the MDM server automatically sending a command or theft notification to the device, which results in the device itself performing security actions. Such actions could be the device turning off; locking; displaying a message to phone the owner; displaying a message indicating that the device is being tracked; degrading its performance; limiting its functionality; capturing screen shots; capturing videos; capturing audio; detecting one or more voices; determining voiceprints; capturing motion; capturing fingerprints; taking photos; taking photos of detail of an iris, taking photos showing detail of one or more fingerprints; zooming in to take close up photos of identifying features; instructing the user to remove glasses, hat or hoodie so that the device can perform better facial recognition, and then taking another photo of the user; displaying a message to instruct the user (potential thief) to press one or more digits of one or both hands onto a screen that is configured to capture fingerprints (under the guise of unlocking the device, for example); instructing the user (potential thief) to wave her fingers over a motion detector and at the same time taking photos and/or a video of the user's hands and/or fingers; instructing the user to wave her hands more slowly over the device, to get a clearer fingerprint photo; displaying a message to the user to look closely into the camera in order that a photo of her iris can be taken; capturing contents of “tasks”, “notes”, “contacts”, “call history” and “calendar” features or applications running on the device, particularly if any changes are made to them; capturing information that is stored in any other applications running on the device that are configured to store user-added information; recording text messages; recording motion of the device; recording the time; recording the weather, temperature or humidity; recording screen shots; capturing information on the SIM card; capturing the IMEI; capturing the IMSI; capturing the mobile telephone number assigned to the device; capturing photos of faces; capturing handwriting entered into the device, and sending any information captured to the MDM server for analysis, collation, face recognition, voiceprint recognition, fingerprint recognition, and reporting to the police. Some of the analysis may be done on the device itself, for example, speech that is detected may be converted to text and sent to the MDM server as text.

Step 241 (FIG. 5) is but one way in which the device connects to the company 202 post-theft. The system will work equally well if the device connects to the company via other than the online media store. For example, the thief may connect to another online store of the company which sells goods other than media, such as computers, operating systems, accessories and smart phones. It may connect to the company via an online support system. It may connect to an online service for providing television programming. Any other services the company offers may be connected to by the device, including video calling, a game center, a media suggestion service, an application suggestion service, a regular photo application, a professional photo application, a web-based storage or backup service, a chat service, a message service, a device tracking service, a work sharing application, a personal profile, a registration service, a service for sharing media across multiple devices, a queuing service, a service for assisting the disabled to interact with a device, and a service provided by any other application. These are a limited set of examples, and the device could connect via any channel to the company post-theft. It is important that all possible channels are examined to determine whether a stolen device has connected to the company. Such channels should all be specified or otherwise covered in the subpoena sent to the company, as a party who is subpoenaed is only obliged to follow the wording in the subpoena. If more information is provided than is requested in a subpoena, then the subpoenaed party may become guilty of violating privacy.

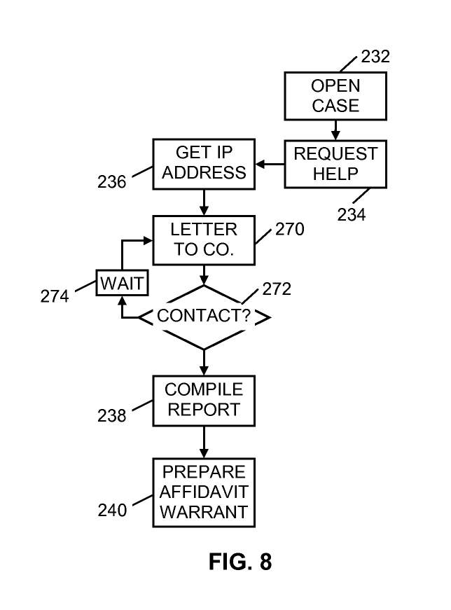

FIG. 8 shows an additional process that the MDM may undertake, in addition to the steps shown in FIG. 5. Upon receipt of a request for assistance or an approval to assist from the police, the MDM sends, in step 270, an automated email in the name of the police officer to the company or companies to which the device may have re-registered or registered. The letter may be sent following a suitable time delay after the reporting of the theft, to allow time for the thief to sell it to someone who would use it. The letter may be sent conditionally upon the device currently being used, and providing IP address or other location information. The letter asks whether the device has (re-)registered after the date of the theft, or has used any of the services provided by the company after the date of the theft. Usually, a company will be able to provide such device-specific information to the police but will not be able to provide any further information, such as personal information unless it is subpoenaed. If, in step 272, the company responds within a set period of time (e.g. 48 hours) saying that the device has made contact with it, in whatever way, then the process performed by the MDM server can continue to the eventual preparation of the affidavit and warrant templates in step 240. If, in step 272, the company responds that the device has not made contact, or if there be no response, then the MDM server proceeds to wait 274 for a period of time before sending another letter to the company in step 270. The period of time may be four weeks or six weeks, for example. Alternately, the MDM may send the letter to the police officer to be sent to the company directly from the police officer. In the letter it is important to specify all the ways that the device may contact the company, or to indicate that information regarding contact in any way is sought.

Prior to the theft being reported, the device itself may detect that it has been stolen. For example, the device may detect that a predetermined number of incorrect password attempts have been made in order to try to unlock the device, where a password may be alphanumeric, a voice input, a biometric input, an on-screen gesture or an air gesture, for example. As soon as a series of such incorrect password entry attempts is detected then the device may invoke one or more of the security actions mentioned above.

Motion detectors in the device may determine that the device has been stolen. For example, the owner of the device may be walking down the street checking his text messages and listening to music. An opportunistic thief may snatch the device and run away into the crowd or into an alley before the owner has chance to react. Upon the motion detector (e.g. tri-axial accelerometer) detecting such an abrupt change in motion, the device can automatically lock and undertake other security measures. The device may record the pattern of motion; take photos, videos and record sound; record the time of the change; respond to a shout of “help” from the owner, using voice recognition software, and automatically dial the police as a consequence. Recording may be stealthy so as not to alert a thief.

In a similar way, the behavioral use of the device may be monitored in order to detect any unusual change in the behavioral pattern, which may be used to detect a theft.

The device may continually make a rolling recording of its environment (motions, sounds, location, weather, temperature, snapshots, screenshots, videos, audio, etc.), saving information going back a predetermined amount of time only, such as an hour. In the event of a detection of theft, the environment information stored in the memory is not erased, but sent to the MDM server, together with an ongoing recording of the environment post-theft. Recording may be stealthy so as not to alert a thief.

In step 254, retrieved information may include any and all user information, including but not limited to name, nickname, address, date of birth, telephone number(s), email address(es) for the device, its registration, its use, or use of services and applications by the device. Additional device identification may be requested, for confirmation or completion of the record, including, but not limited to unique device identifier, serial number, IMSI, IMEI and MEI. Requests may be made for login names, screen names, user names, registration information, billing information, credit card information, IP addresses, geolocation information, telephone numbers dialed, numbers from which calls have been received regardless of whether they were answered or not.

The same principle may be applied to many kinds of electronic devices besides mobile communication devices, including devices that may have electronics added to them. Devices such as televisions, toasters, hi-fi equipment, fridges, cameras, bicycles, cars, barbecues, toys, washing machines etc. may be protected with the system.

Embodiments of the invention provide for a mobile device management system to capture as much location information as possible when a device is reported stolen and before the device is factory reset. Location information may be sent to the police along with a pre-prepared affidavit and search warrant. The warrant may be used to retrieve data relating to the stolen device from an online media store to which the device will likely connected. A police officer may request a local judge to sign the warrant so that the device and current user information can be retrieved from the online store in order to help investigate the theft.

What is claimed is:

1. A non-transitory machine-readable storage medium storing one or more sequences of instructions, which when executed, cause:
in response to a server receiving electronic notification that a device has been stolen, the server composing a legal requisition document by performing:
receiving an identification of the device;
retrieving a legal requisition template for use in a particular jurisdiction where the device was stolen; and
upon consulting a database which stores information about police departments of a plurality of jurisdictions, composing the legal requisition document using the template, the identification, and data retrieved from the database; and
the server electronically sending the legal requisition document to a police department associated with the particular jurisdiction.

2. The non-transitory machine-readable storage medium of claim 1, wherein the legal requisition document is a subpoena or a search warrant.

3. The non-transitory machine-readable storage medium of claim 1, wherein execution of the one or more sequences of instructions further causes:
upon the server receiving notification that a police officer has signed an affidavit in support of the legal requisition document, the server routing the signed affidavit and legal requisition document to a judge or judicial recipient associated with the particular jurisdiction.

4. The non-transitory machine-readable storage medium of claim 3, wherein execution of the one or more sequences of instructions further causes:
upon the server receiving notification that the judge or the judicial recipient has approved the legal requisition document, the server routing the approved legal requisition document to the police department associated with the particular jurisdiction for enforcement.

5. The non-transitory machine-readable storage medium of claim 3, wherein execution of the one or more sequences of instructions further causes:
upon the server receiving notification that the judge or the judicial recipient has approved the legal requisition document, the server routing the approved legal requisition document to a company with which the device may electronically interact or communicate.

6. The non-transitory machine-readable storage medium of claim 5, wherein execution of the one or more sequences of instructions further causes:
receiving, from the company, data describing activity of the device which occurred after the device was reported stolen; and
the server electronically sending a further legal requisition document to the police department associated with the particular jurisdiction, wherein the further legal requisition document includes the data describing activity of the device which occurred after the device was reported stolen.

7. The non-transitory machine-readable storage medium of claim 1, wherein execution of the one or more sequences of instructions further causes, prior to composing the legal requisition document:
the server to send, in the name of the police department associated with the particular jurisdiction, a request to a company which the device may contact, the request being whether the device has made contact with the company after it has been stolen;
upon the server failing to receive a response from the company after a specified period of time, the server resending the request to the company or electronically notifying the police department associated with the particular jurisdiction that the company has not responded to the legal requisition document; and
the server receiving a response from the company indicating that the device has contacted the company after it has been stolen.

8. The non-transitory machine-readable storage medium of claim 1, wherein execution of the one or more sequences of instructions further causes:
receiving data, sent from and recorded by the device, describing activity of the device which occurred after the device was reported stolen; and
the server revising the legal requisition document to comprise or composing a further legal requisition document to comprise the data describing activity of the device which occurred after the device was reported stolen.

9. The non-transitory machine-readable storage medium of claim 1, wherein the device sends the electronic notification to the server, without human intervention, in response to the device determining that the device has been stolen.

10. The non-transitory machine-readable storage medium of claim 1, wherein the electronic notification is issued by the police department associated with the particular jurisdiction.

11. The non-transitory machine-readable storage medium of claim 1, wherein the server composing the legal requisition document further comprises:
the server instructing the device to send location information to the server describing the present location of the device, wherein the legal requisition document sent to the police department associated with the particular jurisdiction comprises the location information.

12. An apparatus for composing and managing the workflow of a legal requisition document, comprising:
one or more processors; and
one or more non-transitory machine-readable storage mediums storing one or more sequences of instructions, which when executed by the one or more processors, cause:
in response to a server receiving electronic notification that a device has been stolen, the server composing a legal requisition document by performing:
receiving an identification of the device;
retrieving a legal requisition template for use in a particular jurisdiction where the device was stolen; and
upon consulting a database which stores information about police departments of a plurality of jurisdictions, composing the legal requisition document using the template, the identification, and data retrieved from the database; and
the server electronically sending the legal requisition document to a police department associated with the particular jurisdiction.

13. The apparatus of claim 12, wherein the legal requisition document is a subpoena or a search warrant.

14. The apparatus of claim 12, wherein execution of the one or more sequences of instructions further causes:
upon the server receiving notification that a police officer has signed an affidavit in support of the legal requisition document, the server routing the signed affidavit and the legal requisition document to a judge or judicial recipient associated with the particular jurisdiction.

15. The apparatus of claim 14, wherein execution of the one or more sequences of instructions further causes:
upon the server receiving notification that the judge or the judicial recipient has approved the legal requisition document, the server routing the approved legal requisition document to the police department associated with the particular jurisdiction for enforcement.

16. The apparatus of claim 12, wherein execution of the one or more sequences of instructions further causes:
upon the server receiving notification that the judge or the judicial recipient has approved the legal requisition document, the server routing the approved legal requisition document to a company with which the device may electronically interact or communicate.

17. The apparatus of claim 16, wherein execution of the one or more sequences of instructions further causes:
receiving, from the company, data describing activity of the device which occurred after the device was reported stolen; and
the server electronically sending a further legal requisition document to the police department associated with the particular jurisdiction, wherein the further legal requisition document includes the data describing activity of the device which occurred after the device was reported stolen.

18. The apparatus of claim 16, wherein execution of the one or more sequences of instructions further causes, prior to composing the legal requisition document:
the server to send, in the name of the police department associated with the particular jurisdiction, a request to a company which the device may contact, the request being whether the device has made contact with the company after it has been stolen;
the server to send, in the name of the police department associated with the particular jurisdiction, a request to a company which the device may contact, the request being whether the device has made contact with the company after it has been stolen;
upon the server failing to receive a response from the company after a specified period of time, the server resending the request to the company or electronically notifying the police department associated with the particular jurisdiction that the company has not responded to the legal requisition document; and
the server receiving a response from the company indicating that the device has contacted the company after it has been stolen.

19. The apparatus of claim 12, wherein execution of the one or more sequences of instructions further causes:
receiving data, sent from and recorded by the device, describing activity of the device which occurred after the device was reported stolen; and
the server revising the legal requisition document to comprise or composing a further legal requisition document to comprise the data describing activity of the device which occurred after the device was reported stolen.

20. The apparatus of claim 12, wherein the device sends the electronic notification to the server, without human intervention, in response to the device determining that the device has been stolen.

21. The apparatus of claim 12, wherein the electronic notification is issued by the police department associated with the particular jurisdiction.

22. The apparatus of claim 12, wherein the server composing the legal requisition document further comprises:
the server instructing the device to send location information to the server describing the present location of the device, wherein the legal requisition document sent to the police department associated with the particular jurisdiction comprises the location information.

23. A method for programmatically composing a legal requisition document, comprising:
in response to a server receiving electronic notification that a device has been stolen, the server composing a legal requisition document by performing:
receiving an identification of the device;
retrieving a legal requisition template for use in a particular jurisdiction where the device was stolen; and
upon consulting a database which stores information about police departments of a plurality of jurisdictions, composing the legal requisition document using the template, the identification, and data retrieved from the database; and
the server electronically sending the legal requisition document to a police department associated with the particular jurisdiction.
